(19) United States
(12) Patent Application Publication
(10) Pub. No.: US 2010/0078419 A1
(43) Pub. Date: Apr. 1, 2010

(54) POST-LENS STEERING OF A LASER BEAM FOR MICRO-MACHINING APPLICATIONS

(75) Inventors: Brian JOHANSEN, Portland, OR (US); Mehmet Ermin ALPAY, Portland, OR (US); Jeff HOWERTON, Portland, OR (US)

Correspondence Address: Electro Scientific Industries Inc.;c/o Young Basile Hanlon & MacFarlane, P.C., 3001 West Big Beaver Rd., Ste. 624, Troy, MI, 48084, US

(73) Assignee: ELECTRO SCIENTIFIC INDUSTRIES, INC, Portland, OR (US)

(21) Appl. No.: 12/238,929

(22) Filed: Sep. 26, 2008

(51) Int. Cl. B23K 26/02

(52) U.S. Cl. 219/121.79

(57) ABSTRACT

In a laser micro-machining system including a simple focusing lens located between a laser source and a beam steering mechanism along the path of a laser beam pulse. The focusing lens being a simple single-element spherical lens with an optical axis of the focusing lens located inline with a laser beam input from the laser source. The focusing lens located further away from a work piece than the beam steering mechanism. An active beam path management system moves the simple focusing lens in concert with and relative to the beam steering mechanism to maintain a focal point coincident with a surface of the work piece at all deflection angles affected by the beam steering mechanism. The focusing lens is rapidly moveable in concert with the beam steering mechanism to maintain a constant beam path length from the lens output to the work piece at all times.

### FIELD OF THE INVENTION

The present invention relates to post-lens steering of a laser beam for micro-machining applications allowing elimination of complex and expensive f-theta lenses in laser micro-machining systems.

### BACKGROUND

Many laser micro-machining systems include fast beam-steering mechanisms (such as a pair of galvanometers) to deflect the laser beam in order to rapidly move the beam spot on the work surface. In a typical implementation, the angular deflection of the beam by the aforementioned fast beam-steering mechanism is translated to planar motion on the work surface via an “f-theta” lens (also known as a “telecentric lens” or “scan lens”). When the beam steering mechanism is located at the front focal point of the lens and the input beam is collimated, the result is a converging (focusing) output beam that is also parallel to the optical axis. In most cases, this arrangement is coupled with a part chuck that presents a work surface that is perpendicular to the optical axis: as such, the (focusing) beams emanating from the f-theta lens impact the work piece at a 90-degree angle. A typical arrangement is illustrated in FIG. 2, where a laser micro-machining system 10a includes a laser source 12a positioned to direct a path 14a of a laser beam pulse through a beam steering mechanism 16a and an f-theta focusing lens 16a toward a work piece 20a.

### SUMMARY

A laser micro-machining system includes a laser source positioned to direct a path of a laser beam pulse through a beam steering mechanism and a focusing lens toward a work piece. According to one embodiment of the invention, the focusing lens is a simple focusing lens located between the laser source and the beam steering mechanism along the path of the laser beam pulse. In another embodiment, the focusing lens is a simple single-element spherical lens with an optical axis of the focusing lens located inline with a laser beam input from the laser optical axis of the focusing lens located inline with a laser beam input from the laser source. The focusing lens is located further away from the work piece than the beam steering mechanism to reduce susceptibility of the focusing lens to contamination by debris generated during a machining operation with the laser source. In another embodiment, an active beam path management system moves the simple focusing lens in concert with and relative to the beam steering mechanism to maintain a focal point coincident with a surface of the work piece at all deflection angles affected by the beam steering mechanism. The focusing lens is rapidly moveable in concert with the beam steering mechanism to maintain a constant beam path length from the lens output to the work piece at all times.

In one embodiment of the invention, a process for laser micro-machining includes a laser source positioned to direct a path of a laser beam pulse through a beam steering mechanism and a focusing lens toward a work piece. The process includes locating a simple focusing lens between the laser source and the beam steering mechanism along the path of the laser beam pulse. In another embodiment, the process includes locating a simple single-element spherical focusing lens with an optical axis inline with a laser beam input from the laser source. The process includes locating the focusing lens further away from the work piece than the beam steering mechanism to reduce susceptibility of the focusing lens to contamination by debris generated during a machining operation with the laser source. In another embodiment, the process includes moving the simple focusing lens in concert with and relative to the beam steering mechanism to maintain a focal point coincident with a surface of the work piece at all deflection angles affected by the beam steering mechanism with an active beam path management system. The focusing lens is rapidly moveable in concert with the beam steering mechanism to maintain a constant beam path length from the lens output to the work piece at all times.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a schematic view of a beam-steering arrangement preceded by simple focusing lens according to one embodiment of the invention including an “active beam-path management” concept for maintaining focus on a work surface at different deflection angles affected by the beam-steering mechanism; and

FIG. 2 is a schematic view of a typical beam-steering arrangement followed by an f-theta lens.

### DETAILED DESCRIPTION

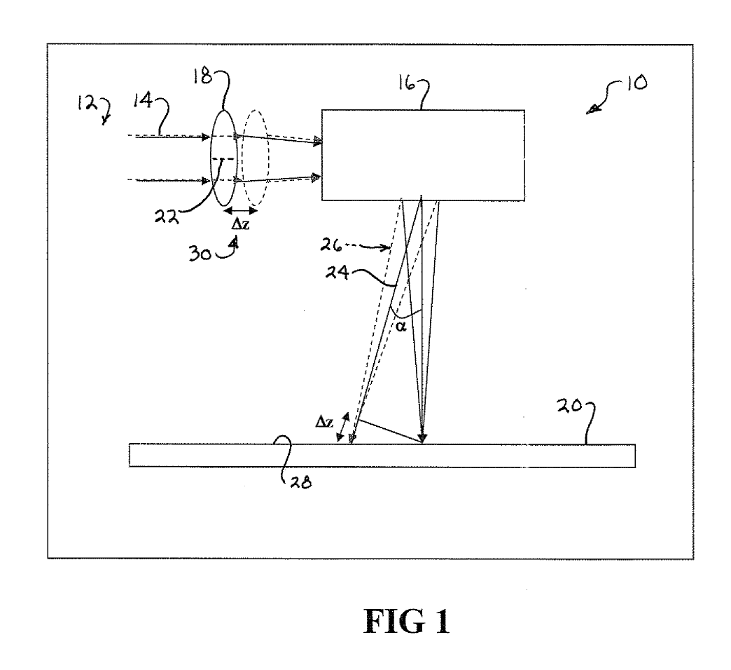

Referring now to FIG. 1, a laser micro-machining system 10 includes a laser source 12 positioned to direct a path 14 of a laser beam pulse through a beam steering mechanism 16 and a focusing lens 18 toward a work piece 20. The focusing lens according to one embodiment of the invention, can be a simple focusing lens 18 located between the laser source 12 and the beam steering mechanism 16 along the path 14 of the laser beam pulse toward the work piece 20. In one embodiment of the invention, the focusing lens can be a simple single-element spherical lens 18. The laser beam input or path 14 to the focusing lens 18 from the laser source 12 at least immediately adjacent to the focusing lens 18 is inline with an optical axis 22 of the focusing lens 18 at all times. It should be recognized that the path 14 of the laser beam pulse can be redirected between the laser source 12 and the focusing lens 18 by devices known to those skilled in the art prior to being coaxially aligned with the optical axis 22 of the focusing lens 18 prior to entering the focusing lens 18. According to an embodiment of the invention, the focusing lens 18 is located further away from the work piece 20 than the beam steering mechanism 16, thereby reducing the susceptibility of the focusing lens 18 to contamination by debris generated during a machining operation with the laser source 12 on the work piece 20. A path 24 of an output beam 26 from the beam steering mechanism 16 can hit a surface 28 of the work piece 20 at an angle α including angles other than a right angle.

An embodiment of the invention can also include an active beam management system 30. The active beam management system 30 can move the simple focusing lens 18 in concert with and relative to the beam steering mechanism 16 to maintain a focal point coincident with a surface 28 of the work piece 20 at all deflection angles a affected by the beam steering mechanism 16. The focusing lens 18 can be rapidly moved in concert with the beam steering mechanism 16 to maintain a constant length beam path 24 between the focusing lens 18 and the work piece 20 at all times.

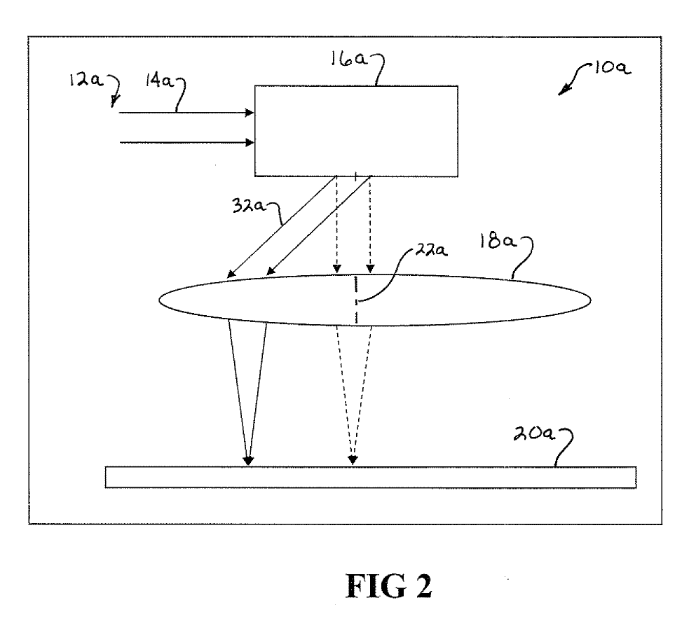

A process for laser micro-machining including a laser source 12 positioned to direct a path 14 of a laser beam pulse through a beam steering mechanism 16 and a focusing lens 18 toward a work piece 20 according to an embodiment of the invention includes locating a simple focusing lens 18 between the laser source 12 and the beam steering mechanism 16 along the path 14 of the laser beam pulse. In a typical configuration, the focusing lens 18a is located downstream from, or after the beam steering mechanism 16a, as best seen in FIG. 2, which requires an f-theta lens 18a. The configuration illustrated in FIG. 1 allows the simple focusing lens 18 to be a simple single-element spherical lens 18. This configuration reduces the cost of the focusing lens substantially when compared to the typical configuration. Locating the focusing lens 18 further away from the work piece than the beam steering mechanism, as illustrated in FIG. 1, reduces the susceptibility of the focusing lens 18 to contamination by debris generated during a machining operation with the laser source 12. The process can include aligning the path 14 of the laser beam pulse input to the focusing lens 18 from the laser source 12 to be inline with an optical axis 22 of the focusing lens 18 at all times. It should be recognized that the path 14 of the laser beam pulse can be redirected between the laser source 12 and the focusing lens 18 by devices known to those skilled in the art prior to being coaxially aligned with the optical axis 22 of the focusing lens 18 prior to entering the focusing lens 18. The process can include hitting a surface 28 of a work piece 20 with a path 24 of the output beam 26 from the beam steering mechanism 16 at an angle α including an angle other than a right angle. The simple focusing lens 18 can be moved according to an embodiment of the process of the invention in concert with and relative to the beam steering mechanism 16 to maintain a focal point coincident with a surface 28 of the work piece 20 at all deflection angles α affected by the beam steering mechanism 16 with an active beam path management system 30. The process can include rapidly moving the focusing lens 18 in concert with the beam steering mechanism 16 to maintain a constant length beam path 24 between the focusing lens 18 and the work piece 20 at all times.

In this invention, a beam focusing/steering arrangement for a laser micro-machining system 10 is used in which the focusing lens 18 precedes the beam-steering mechanism 16. Such an approach provides benefits compared to a “standard” configuration. First, the input beam to the focusing lens 18 can be aligned with the optical axis 22 of the focusing lens 18 at all times. Consequently, a simple single-element spherical lens 18 is sufficient in this arrangement. This is a much more favorable arrangement than the arrangement illustrated in FIG. 2 where the focusing lens 18a has to be an f-theta lens 18a which is significantly more complex (i.e. a multi-lens element) and hence more expensive. Second, the arrangement illustrated in FIG. 1 also leaves the focusing lens 18 further away from the work piece 20, reducing susceptibility of the focusing lens 18 to contamination by the debris generated during a machine operation. The optical configuration in FIG. 1 illustrates beam steering/focusing optics in a laser micro-machining system (beam steering mechanism preceded by a simple focusing lens). FIG. 1 also shows that the focusing lens 18 can be repositioned Δz to maintain a focal point coincident with the work piece surface 28 at all deflection angles α affected by the beam steering mechanism 16. Depending on application requirements and how much the beam path 24 changes Δz as a result of beam deflection α, such active beam path management 30 may or may not be necessary. The change in the beam path 24 length from beam steering mechanism 16 to the work piece 20 can be compensated by moving the focusing lens 18 in concert with the beam steering mechanism 16 to provide active beam path management 30.

Nevertheless, this design has some drawbacks. First, in the design illustrated in FIG. 1, the output beam 26 from the beam-steering device 16 will not always hit the work surface 28 at a right angle. Depending on the application requirements, this may or may not be tolerable. In those cases where a distance between the beam-steering device 16 and the work piece 20 is fairly long when compared to the desired spot size movement on the work piece 20 as a result of beam-steering, the change (from vertical) in this “angle of attack” will be fairly small. Second, the mismatch between the curved focal surface of the focusing lens 18 versus the flat surface 28 of work piece 20 is a problem in this particular case as well. The design as illustrated in FIG. 1 provides that the focusing lens 18 can be moved Δz in concert with the beam-steering optics 16 to maintain a constant beam path 24 length from the lens 18 output to the work piece 20 at all times. Note that such active management of the beam path 24 requires the ability to rapidly move the focusing lens 18. This becomes possible in this design as the element being moved is a small single-element focusing lens 18 as opposed to a large multi-element f-theta lens 18a as illustrated in FIG. 2.

The “standard” optical configuration that calls for beam-steering optics 16a followed by an f-theta lens 18 as illustrated in FIG. 2 is an expensive and, in some cases, difficult-to-implement solution due to the complexity of the f-theta lens 18a itself. This complexity arises from two primary reasons. First, the presence of beam steering optics 16a prior to the lens 18a indicates that the input beam 32a to the lens 18a is not necessarily along the optical axis 22a. The “angle of attack” for the input beam 32a to the scan lens 18a is likely to vary in real-time during machine operation. Second, more often than not, the work piece 20 is flat, whereas the back focal “surface” of a standard spherical focusing lens 18 would be curved. The need to accommodate input beams 32a that are not parallel to the optical axis 22a and maintaining focus on essentially flat work pieces 20 (or sub-regions thereof) typically requires complicated multi-lens designs. As such, an f-theta lens 18a typically includes multiple lenses whose optical properties and physical placement (within the multi-element structure) are very carefully optimized to reduce the aberrations that would otherwise result from the two issues listed above.

As a consequence of the fundamental design challenges outlined above, f-theta lenses 18a are usually complicated, relatively large, difficult to manufacture and expensive. The cost issue becomes even more important when one realizes that these lenses 18a, more often than not, are the very last component in the optical train: i.e., the lenses 18a are in physical proximity to the work piece 20 and thus more susceptible to contamination from the debris generated during machine operation. Needless to say, having to replace such expensive elements on a regular basis has a big impact on the cost of ownership of the system.

Replacing the “post beam-steering f-theta lens” 18a with a “pre beam-steering standard lens” 18 immediately resolves the first issue: the input beam path 14 to such a lens 18 is “fixed” and can always be made to align with the optical axis 22 of the lens. Furthermore, such a lens 18 will be typically positioned much further away from the work piece 20 and hence will not be as susceptible to contamination problems and, even if the lens 18 were subject to contamination, regular replacement of such a part would be an acceptable maintenance strategy as the part itself would be an order of magnitude cheaper than an f-theta lens 18a, if not more.

As for the issue of maintaining focus on a flat work piece 20: if the work piece 20 area that needs to be “scanned” via beam-steering motion is small enough compared to the focal length of the lens 18, the resulting spot size change might very well be negligible and/or insignificant for the application domain in question. Otherwise, the “active beam-path management” mechanism 30 outlined above can be used to mitigate the effects of this problem.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. In a laser micro-machining system including a laser source positioned to direct a path of a laser beam pulse through a beam steering mechanism and a focusing lens toward a work piece, the improvement of the focusing lens comprising:
a simple focusing lens located between the laser source and the beam steering mechanism along the path of the laser beam pulse.

2. The improvement of claim 1 further comprising:
an active beam path management system moving the simple focusing lens in concert with and relative to the beam steering mechanism to maintain a focal point coincident with a surface of the work piece at all deflection angles affected by the beam steering mechanism.

3. The improvement of claim 1, wherein the focusing lens is a simple single-element spherical lens.

4. The improvement of claim 1, wherein the path of the laser beam pulse input to the focusing lens from the laser source is inline with an optical axis of the focusing lens at all times.

5. The improvement of claim 1, wherein the focusing lens is located further away from the work piece than the beam steering mechanism reducing susceptibility of the focusing lens to contamination by debris generated during a machining operation with the laser source.

6. The improvement of claim 1, wherein a path of an output laser beam pulse from the beam steering mechanism hits a surface of the work piece at an angle including angles other than a right angle.

7. The improvement of claim 1, wherein the focusing lens is rapidly moveable in concert with the beam steering mechanism to maintain a constant length of a path of the laser beam pulse output from the focusing lens to the work piece at all times.

8. In a laser micro-machining system including a laser source positioned to direct a path of a laser beam pulse through a beam steering mechanism and a focusing lens toward a work piece, the improvement of the focusing lens comprising:
a simple focusing lens located between the laser source and the beam steering mechanism along the path of the laser beam pulse, the focusing lens being a simple single-element spherical lens with an optical axis of the focusing lens located inline with a laser beam input from the laser source, the focusing lens located further away from the work piece than the beam steering mechanism thereby reducing susceptibility of the focusing lens to contamination by debris generated during a machining operation with the laser source; and
an active beam path management system moving the simple focusing lens in concert with and relative to the beam steering mechanism to maintain a focal point coincident with a surface of the work piece at all deflection angles affected by the beam steering mechanism, the focusing lens rapidly moveable in concert with the beam steering mechanism to maintain a constant length of a path of the laser beam pulse output from the focusing lens to the work piece at all times.

9. In a process for laser micro-machining including a laser source positioned to direct a path of a laser beam pulse through a beam steering mechanism and a focusing lens toward a work piece, the improvement of the process comprising:
locating a simple focusing lens between the laser source and the beam steering mechanism along the path of the laser beam pulse.

10. The improvement of claim 9 further comprising:
moving the simple focusing lens in concert with and relative to the beam steering mechanism to maintain a focal point coincident with a surface of the work piece at all deflection angles affected by the beam steering mechanism with an active beam path management system.

11. The improvement of claim 9, wherein the focusing lens is a simple single-element spherical lens.

12. The improvement of claim 9 further comprising:
aligning a path of the laser beam pulse input to the focusing lens from the laser source to be inline with an optical axis of the focusing lens at all times.

13. The improvement of claim 9 further comprising:
locating the focusing lens further away from the work piece than the beam steering mechanism thereby reducing susceptibility of the focusing lens to contamination by debris generated during a machining operation with the laser source.

14. The improvement of claim 9 further comprising:
hitting a surface of the work piece with a path of an output beam from the beam steering mechanism at an angle including angles other than a right angle.

15. The improvement of claim 9 further comprising:
rapidly moving the focusing lens in concert with the beam steering mechanism to maintain a constant length of the path of the laser beam pulse output from the focusing lens to the work piece at all times.
